(19) United States
(12) Patent Application Publication
(10) Pub. No.: US 2004/0215719 A1
(43) Pub. Date: Oct. 28, 2004

(54) Method and system for designing, editing and publishing web page content in a live internet session

(76) Inventor: Dennis Wayne Altshuler, Gilbert, AZ (US)

Correspondence Address: WEISS & MOY PC, 4204 NORTH BROWN AVENUE, SCOTTSDALE, AZ, 85251, US

(21) Appl. No.: 10/410,780

(22) Filed: Apr. 9, 2003

(51) Int. Cl. G06F 15/16

(52) U.S. Cl. 709/204

(57) ABSTRACT

A method and system for designing, editing and publishing web page content in a live Internet session provides on-line and transparent web page design and publishing with professional quality output. Software on the server providing an editing session receives information from user interface helpers merged with the actual web page content for detecting mouse selection of web page objects. Upon single-click selection of an object or other page location, the server pushes a test page having a superimposed edit menu. Upon double-click selection of an object, a layer unique to the object is “floated” for repositioning of the object. Changes to the web page are made by sending information about all mouse clicks and associated coordinates to the server, which locates the edited object from the coordinates and updates database. The web page view is regenerated and pushed after de-selection of objects during the editing session by interpreting the database. A page generation engine generates the code for implementing the full web page view from the database, which is published upon a command from the user.

### BACKGROUND OF THE INVENTION

1. Field of the Invention

The present invention relates generally to web page generation and site management, and more specifically, to a method and system for designing, editing and publishing web page content in a live Internet session.

2. Background of the Invention

The Internet, and in particular, the World-Wide-Web (WWW) have become some of the predominant sources of information, commercial interaction, interpersonal communication, interactive education and entertainment available today. Web pages comprising websites are generated and managed by both commercial users and individuals.

Website generation generally requires generation of one or more files implementing web pages, linking the pages to various resource descriptors (such as Internet Universal Resource Descriptors—URLs) within the pages and on other Internet locations and placing the files in an appropriate directory so that the website and web pages can be accessed by an Internet user. Various other network implementations called Intranets and Extranets have also been implemented, and the web page and website management and generation tasks are typically the same as for WWW sites. The above tasks are generally accomplished in one of two ways: use of on-line or off-line website management software and associated tools.

On-line website management is accomplished by Internet access to a server program that typically also uses downloaded control software on the local machine to support its operation. Such software typically uses Hypertext Markup Language (HTML) to generate web pages and thus permits control of web page content only to the degree that HTML supports. For example, to implement positioning of graphical elements on the screen that are not organized in a vertical column, tables are used to place the graphics within a grid pattern determined by HTML screen positions. While such tools are generally considered useable by individuals generating personal websites, the on-line website management software packages currently available are not suited for generation of web page content to present-day professional web design standards.

On-line website management typically is also very restrictive with respect to generating custom code. HTML editors are typically implemented in such tools and the software may include the ability to place links within the HTML pages to controls that are implemented as Applets, but typically the controls are limited to a few features such as hit counters, clocks, calendars and the like. The interfaces of such on-line website management programs are typically fragmented and difficult to use. For example, file management may be provided by a separate FTP interface, while the HTML editing is provided within a special web page for layout control.

A particular advantage, however, of on-line website management tools is that the operations are performed in almost real-time, as the server stores the generated HTML code and can publish edited or newly generated almost immediately after editing is complete.

Off-line website management software, as used by professional website designers, encompasses a wide range of software tools. Since the programs are generally all executed and hosted on a personal computer, individual licenses are typically purchased by or for each designer and include web page editors and translators, graphics editors, tools for coding JAVA, JavaScript, PERL and other hosted languages, database development platforms, and other tools. After the web pages have been generated, they are typically transferred to the appropriate Internet directory via an FTP application. File management for websites presents a difficulty for businesses that contract with outside services that perform their website design and the businesses often do not posses the software tools or have on-staff personnel trained to make the most trivial changes to a website.

Therefore, it would be desirable to provide a method and system for designing, editing and publishing professional quality website content entirely within an on-line session. It would further be desirable to provide an interface for an on-line website design and management tool that is well-integrated and easy to use.

### SUMMARY OF THE INVENTION

The above objectives of providing professional quality webpage design, editing and publishing within an on-line session is achieved in a method and system. The method includes providing a user interface for live web page displaying and editing that initially consists of a page view identical to a standard browser view, but with a background JavaScript script active for selection of objects for editing. Upon selection of any object on the page view via mouse click, a menu bar appears at the top of the window or in another fixed location. As the web page is scrolled, the menu bar remains fixed within the window. The user interface provides for insertion and movement of multiple web page objects within a high-resolution graphical grid. The JavaScript script records screen coordinates associated with all mouse button activity. The mouse activity is sent to a server that maintains a database of editing activity. The database containing all elements and their location is updated at the server for insertion, removal and repositioning of objects. The database is updated in response to any mouse activity that implicates an object in the web page layout. Upon completion of editing activity on an object, the database is used to regenerate an implementation of the target webpage, including the menu bar if active, on the server and push it to the client browser, providing a real-time real view version (less certain features that are disabled) of the web page with an editing menu superimposed. Upon an indication from the user to publish the web page, the file corresponding to the web page implementation is then copied to the actual web page directory, providing an immediate publication at the end of the live editing session.

The method may be embodied in a computer system including at least one server programmed to carry out the steps of the method coupled to a remote computer executing a web browser for displaying a graphical output (the user interface) provided from the server and carrying out other steps of the method. The method may also be embodied in one or more computer program products storing program instructions for carrying out the steps of the method.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a networked computer system in which the present invention may be practiced.

FIG. 2 is a block diagram depicting software modules in accordance with an embodiment of the present invention.

FIG. 3 is a pictorial diagram depicting a user interface in accordance with an embodiment of the present invention.

FIG. 4 is a pictorial diagram depicting a user interface in accordance with an embodiment of the present invention.

FIG. 5 is a flowchart depicting operation of the server side software in accordance with an embodiment of the present invention.

### DETAILED DESCRIPTION OF THE PREFERRED EMBODIMENTS

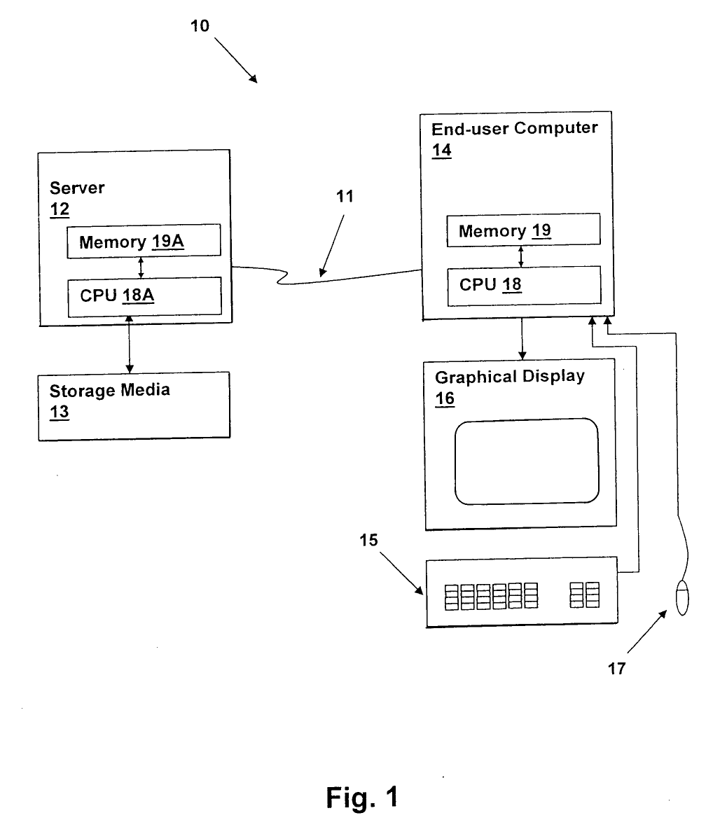

Referring now to the figures and in particular to FIG. 1, a networked computer system 10 within which a preferred embodiment of the present invention may be practiced is depicted in a block diagram. Networked computer system 10 comprises a server 12 coupled to storage media 13, which is generally a hard disk array containing server software and other files. Server 12 serves web pages and provides file transfer over Internet connections such as Internet connection 11. Server 12 includes at least one processor 18A and a memory 19A for storing program instructions and data for implementing the server-side software methods of the present invention. Internet connection 11 couples an end-user computer 14 to server 12. End-user computer 14 has a central processing unit 18 (CPU or processor) for executing program instructions contained in a memory 19 that embody user interface methods of the present invention in the form of browser displays. Memories 19 and 19A should be understood to include non-volatile storage such as hard disk drives and non-volatile memory. End-user computer 14 is coupled to a graphical display 16 on which the user interfaces of the present invention are presented for interaction with the user. A keyboard 15, a mouse 17 and other suitable input devices may be coupled to end-user computer 14 to permit the user to interact with a browser program executing within end-user computer 14.

The present invention is embodied in methods, systems and software for designing, editing and publishing web content at server 12 in response to user input from a browser executing on end-user computer 14. Software executing on end-user computer 14 is generally a standard web browser, but may be a dedicated application or customized browser consistent with the requirements of interfacing server-side applications of the present invention to the user. JavaScript scripts implementing portions of the user interface are used to coordinate user input for editing web content with server 12 software. Server 12 is provided as an example of a single-server application, but tasks and storage described herein may be distributed between many servers.

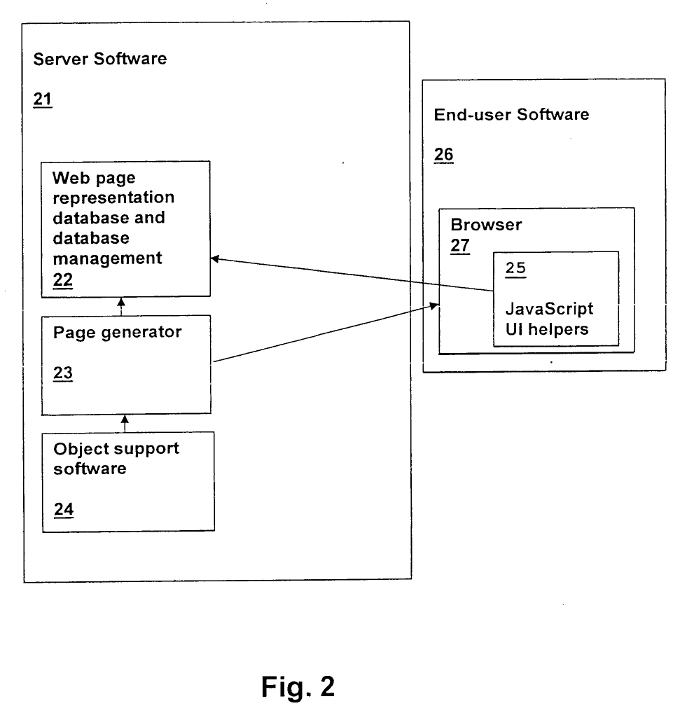

Referring now to FIG. 2, an organization of software modules in accordance with an embodiment of the present invention is depicted. End-user software includes the above-mentioned network browser 27. Within browser, an edit page provided from server 12 is active that includes JavaScript user interface (UI) helpers 25 that send mouse coordinates and button state information to server 12. The edit page is entered via a one-time logon/verification security process and multiple windows can be used to edit multiple pages subsequent to logon without requiring further verification. No other user-side component is required for operation of the present invention. Server software 21 includes a page generator 23 for generating updates to an edited webpage in conjunction with a web page representation database 22 that receives editing information (mouse coordinates and click information) from UI helpers 25. Page generator comprises PHP scripts for generating HTML representing the web pages, but may be implemented in other languages such as PERL or high-level programmatic markup languages such as extensible markup language (XML).

A test web page is viewed and edited by entering the URL of a test web page location in browser 27. Three copies of the page are existent when the test URL is activated. One is a dynamically generated edit view page that is pushed to browser 27. The second is a statically generated test page placed in a test directory that references copies of object data (such as images, etc.) in the test directory and the third is a statically generated page that contains links to the actual object data used in the published web page for optionally copying over the published web page file. Each of the copies is updated each time the web page is regenerated by page generator 23, so that they are in sync with database editing. Upon request for publication, the third copy is copied over the actual web page file. Upon selection of a view test web page command, the second copy is viewed in another browser window. The view test page provides an actual view of the web page without the editing user interface present.

Page generator 23 receives notification that an object on the test web page is selected for editing, by a user input captured by a JavaScript script implementing UI helpers 25 executing on an active page within browser 27 that detects selection of the object via a single-click or double-click (or other suitable selection mechanism) on the test web page. Double-click selection is used to select objects for floating and repositioning, while single-click selection is used to select objects for editing via a menu bar. Double-click selection selects the top-most object when multiple objects are present at the pointing device location. Single-click selection may be repeated on multiple objects to provide simultaneous editing of multiple objects for commands such as align, move, etc.

Prior to selection of an object on the test web page, the page is generated by page generator 23 and viewed as any other web page in a window of browser 27. Upon double-click selection of an object, the object is “floated” in the browser window by UI helpers 25 so that the object will follow a pointing device cursor and the selection point coordinates are captured by UI helpers 25 and sent to server 12, where they are used to find an object that is recorded in database 22. Single-click selection activates a JavaScript implemented menu bar that is one of the UI helpers 25 merged with the test web page content to provide the dynamic edit web page.

Server 12 determines which object was selected by the selection coordinates transmitted from UI helpers and returns the object ID to one of UI helpers 25. The object is deselected after modification and/or repositioning via a single-click which is also transmitted by UI helpers 25 to server 12 along with the object ID. Server 12 then updates database 22 to reflect the edited page. Page generator 23 regenerates the test web page, which is generally HTML, but may include JavaScript or PERL scripts along with web page code and data in other formats such as XML, and pushes the page to browser 27. Insertion of objects is provided by accessing menu bar insert options provided by single-clicking anywhere on the screen, thus permitting insertion of objects on top of other objects.

In order to support the above-described editing functionality, special techniques are used in the design of the HTML implementation of the web pages. Each object generally is placed in a unique layer using the div layer tag. An exception to this is provided when the size of an object is indeterminate (such as for database objects that are generated dynamically) and another object must be positioned relative to the object of unknown size. In order to properly position the other object, the other object may be placed in the same layer.

A layer number is automatically assigned to each entered object by page generator 23, and the layer number is stored in database 22 along with the other object data. When database 22 is accessed to regenerate the page (by reading all of the object entries for the page from database 22), page generator 23 automatically places the objects in individual layers in conformity with the stored layer numbers, permitting UI helpers 25 to float an object by floating the selected object's layer on the test web page. Floating is accomplished by moving the layer's origin point in response to movement of the pointing device.

Database 22 contains all of the information for generating a webpage other than static storage such as image files. Tables within database store records including: 1) Object ID; 2) Secondary database table name (identifying tables containing images, text, JavaScript, other databases, forms, code modules, templates, style sheets and any other type of object that may be inserted in/connected with an object); 3)Secondary database table entry ID; 4) object origin screen coordinates; 5) height and width of object; 6) switches for style sheets; 7) layer number; 8) page tag (the database may contain one or more entire websites); 9) user who added/edited object; 11) active/inactive status; 10) grouping status; 11) group numbers (multiple grouping is supported); 12) template status; 13) template ID and other switches used to control object formatting. Secondary database tables (referenced by primary database entries 2 and 3 above) contain the links to directory locations (e.g., image file name and directory), URLs (import image links and links in general), type dependent switches, and further entries to dependent databases underneath the secondary level.

Object support software 24 is code resident on server 12 that generates page-supporting complex objects presented on web pages generated with the methods of the present invention, and may include PHP code, java programs, JavaScript scripts, PERL scripts, code implemented in other languages, and database interface software for storing and retrieving data from other databases stored on storage media 13, such as spreadsheet and form databases storing numerical and field data from which dynamic or static web content (database objects) are generated.

Special database import/creation functions are incorporated in the software, and a user can import or create a database on-the-fly and insert database views in a web page, specifying formatting and selecting fields from the database for display. The formatting can be dynamic in that each time the page is displayed, the associated database is polled to regenerate the page, or the content may be a one-time static implementation of the database view of the database condition at the time of creation/insertion. For example, a database of sales items including prices, photos and descriptions could be imported as a dynamic database and formatted for viewing, and subsequently a shopping mall page can be maintained by merely adding and deleting entries in the database without editing the web page at all. The software also supports user-generated templates and style sheets that permit a user to collect objects (templates) for re-use on multiple pages and specify the formatting of object types (styles) across multiple objects.

When an editing session is complete, which may be triggered by a user input at a button or on a menu item, or may alternatively be triggered by leaving the test page URL, page generator 23 replaces the active web page file at the actual web page URL-associated storage location with the updated page regenerated from database 22. UI helpers 25 may prompt the user with an option of updating the actual web page, or page generator 23 may do so automatically. As an alternative to file replacement and implementation of static web page files, server software 21 may “spoof” an actual file by always pushing a dynamically-generated page that is generated on the fly by page generator 23 (which may be another page generator program executing from a server for hosting pages that does not include all of the editing functionality of page generator 23). Such a technique can provide a high site volume with low storage requirements that can easily reflect dynamic changes to database 22 or changes in external data used to build web page objects, as the implemented web pages does not have to be statically stored and all web pages may be generated from database 22 dynamically, although images and test associated with objects are still generally stored on storage media 13 as files. The alternative technique may also provide security against direct file copying.

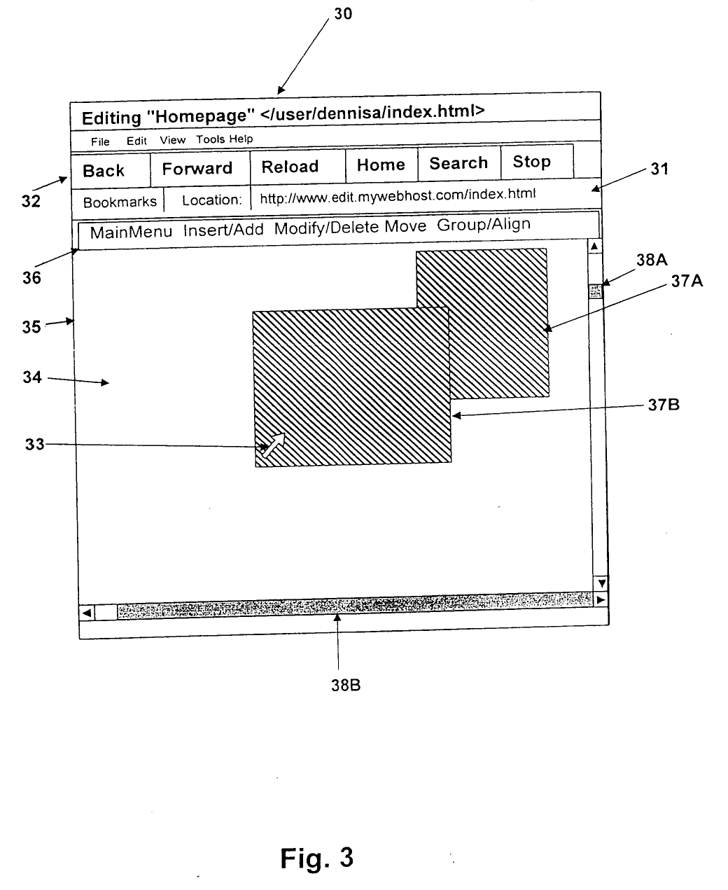

Referring now to FIG. 3, a user interface in accordance with an embodiment of the invention is depicted. Browser 27 graphical output 30 provides standard features such as navigation buttons and menu 32 a URL display and entry window 31, web page viewing window 35, pointing device cursor 33 and scroll bars 38A and 38B. When cursor 33 is positioned on an object 37B (or 37A) on a edit web page 34 accessed via entering an edit URL in location window 31 (or by traveling to a link, activating a bookmark or other similar action that generally invokes a URL location), if object 37B is selected via a double-click, the unique layer containing object 37B is floated, permitting repositioning of object 37B. If object 37B or any coordinate on edit web page 34 is selected via a single-click, edit web page 34 is regenerated to include a menu bar 36 that is presented in the example at the top of edit web page 34, but may be located at other positions or may be definable by the individual user as a “preference” setting. Repositioning of an object may be easily performed by selecting a destination location and selecting the object from the move menu option, the object will be moved to the selected location. An object may also be “floated” by selecting a float option for the object from menu bar 36. When scroll bars 38A and/or 38B are used to move web page viewing window 35 around the test web page 34, web menu bar 34 is automatically moved to maintain the position of test menu bar 36 in the same location within web page viewing window 35. When object 37B is deselected, object 37B is dropped at the current location (if floated) and test web page 34 is regenerated to reflect any changes.

The floating action described above is provided by the use of individual layers for each object, and the “stacking order” of individual objects is a field in the database entry associated with the object, so that the layers may be ordered properly in the database-generated web page output, providing great flexibility in object layering as well as making the process independent of actual layer tag encoding, as the layer tags are generally unique to each object, and are assigned automatically upon object insertion. The above-described technique provides an advantage over previous layer editing systems, where many objects may be present in a layer, requiring separation of objects from a layer in order to reorder them and where the layer tags are hard-coded, requiring editing of the tags in order to reorder/re-layer objects.

The page generation techniques of the present invention further provide advantages in generating “rollovers”, where object content is changed dynamically when the cursor is positioned above the object (mouse over). In the present invention, rollovers are generated automatically, with a separate layer assigned to each rollover and rollover scripts inserted in the generated/regenerated page that are automatically numbered and associated with each rollover object, including both content items that are associated with the two states of the rollover. The content items may be any object item, including images, scripts, program code, text, sounds, midi clips and other data or program types.

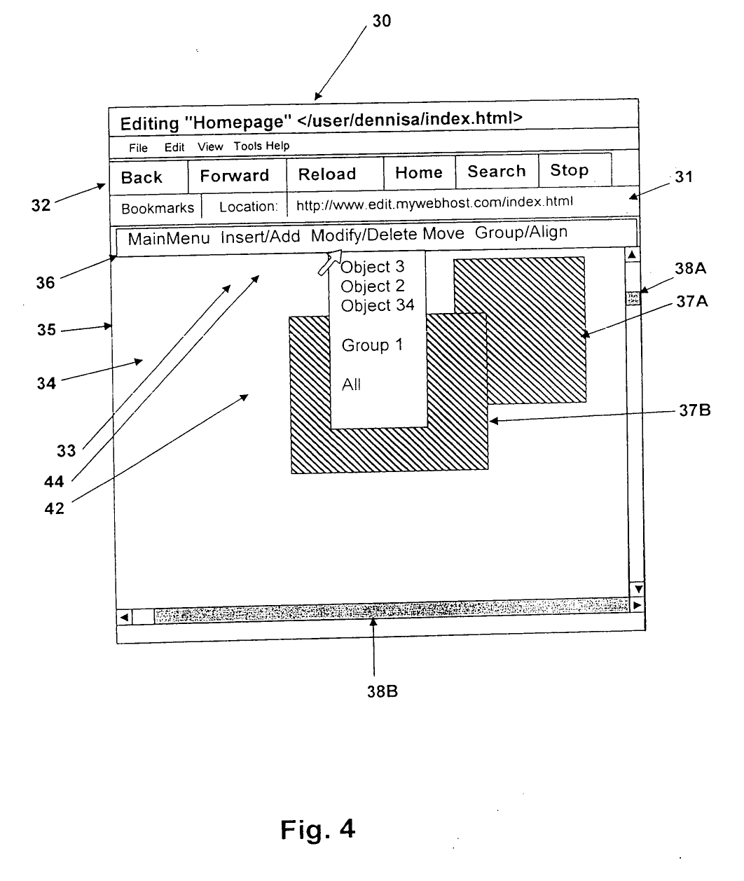

Referring now to FIG. 4, operation of menu bar 36 is illustrated along with other features of a user interface in accordance with an embodiment of the invention. Menu 42 is presented as displayed when activated by cursor 33 (via single-click) and provides a list of modify/insert/delete object options, as well as other editing and administrative functionality. The menus associated with other menu bar 36 options are similar in nature. An object list 44 provides access to selected objects and groups including an “all objects” group generated in conjunction with the web page representation in a database 22. Since database 22 as described above provides a historical trace of all objects edited via UI helpers 25, history lists of object editing operation may be generated and included in menu 44. Menu 44 content is completely flexible, as menu 44 is dynamically regenerated on the test web page 34 in the same manner as menu bar 36. The use of an active web page to implement both the test web page 34 view along with the editor user interface (menu bar 36, menu 44 provided by UI helpers 25) provide seamless integration of editing and display functionality, forward compatibility with browser upgrades, etc. and integration of other editor tools providing within the software of the present invention such as external database import/export and editing controls. Since server 12 controls the display of test web page 34 and the code/database 22 from which the edit, test and actual web pages are generated, any user interface feature can be added to the test web page 34 view as needed and very complex tools may be provided for a user to insert on a web page as objects.

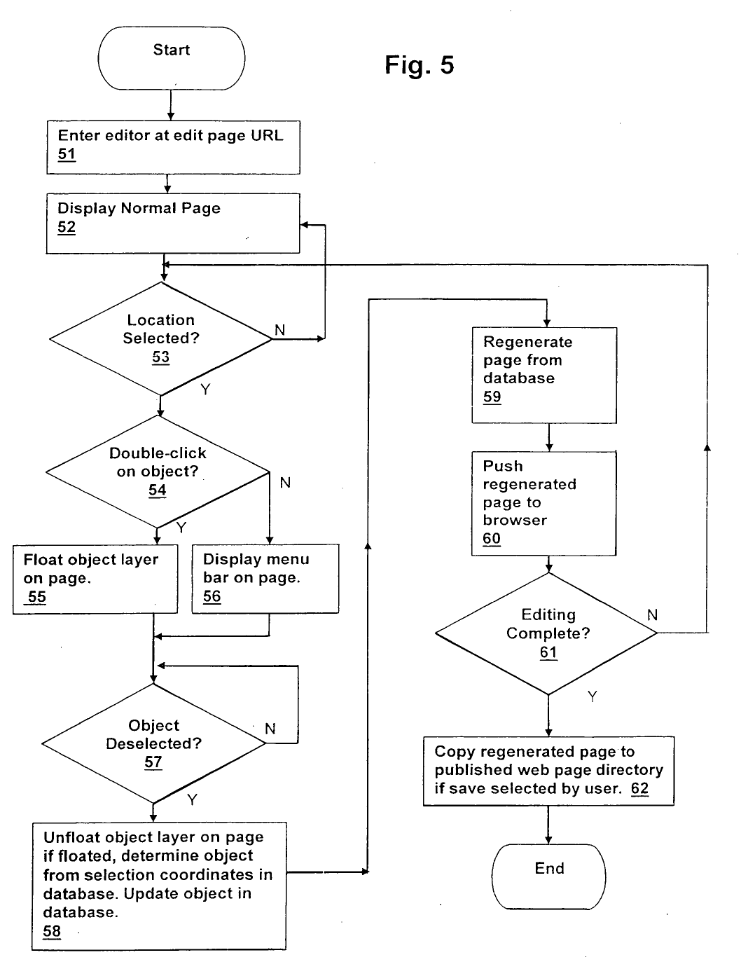

Referring now to FIG. 5, operation of software embodying a method of the present invention within server 12 and UI helpers 25 is depicted. The web page is entered at the edit page URL from browser 27 (step 51) and a copy of a normal view (test view) of the web page is displayed (step 52). Until a location is selected as detected by UI helper (decision 53), the test web page is displayed with some features disabled (step 52). The disabled features are generally JavaScripts that would otherwise interfere with the actions of the editor UI helpers. For example, rollover functionality is disabled in the test web page view. Upon the first selection (decision 53) UI helpers 25 activate the editing process and page generator 23 generates a representation of the edit web page. If a single-click selection was made, edit web page is generated with a menu bar at the top of the page (step 56) and pushes the page to browser 27. If selection was made with a double-click, the selected object is floated by UI helpers 25 floating the object's layer in the browser 27 display (step 55). The selection coordinates are sent by UI helpers 25 to server 12. When the selected object or objects are deselected (decision 57), the deselection coordinates are sent by UI helpers to server 12, the object is located and object information is updated in database 22 and the object is un-floated if it was floated (step 58). Page generator 23 then regenerates the web page based on updated database 22 (step 59) and the output of page generator 23 is sent to browser 27 (step 60). The above steps of selecting, floating, menu bar displaying, updating and regenerating are repeated until the user exits the editor (decision 61). If the user directs publication of the edited version (or when the software is designed to automatically save on exit), the regenerated page is copied over the published web page directory location (step 62).

The above described methods and user interfaces provide a novel on-line editing capability that provides true viewing of web page content and see-as-you-go editing that is both easy to use and as powerful as existing off-line professional design tools. The techniques of the present invention are valuable resources for both user service providers permitting users to edit the pages served by their servers, to businesses and web content design services to simplify the maintenance of websites while providing high quality web content. The techniques further provide an operational advantage for users connected to the Internet via asymmetrical links, as uplink data consists of only mouse click information and coordinates, while the generally higher-bandwidth downlink provided in asymmetrical links provides fast updates from server 12 after page regeneration.

The present invention also provides advantages over a typical off-line or on-line local executable type web-page editor in that not only is the process handled almost entirely at the server (excepting user input capture and transmission), if multiple browser windows are activated at different test pages, the operation of each browser window may independently edit different pages within a website, and without requiring an additional login/verification process, as the browser maintains the connection security until all sessions are ended. A typical on-line editor operates on only one web page at a time.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for editing and displaying an active web page during a live Internet session displaying a test version of said active web page in a page view window of a browser executing on an user computer having a visual display and a pointing device, said end-user computer further coupled to a server via an Internet connection, said method comprising:
first receiving a first user input from a selector of said pointing device at a location on said test web page;
first sending first screen coordinates associated with said first user input to said server;
second receiving a second user input directing modification of an object in conjunction with said first user input;
locating a database entry for said object within a web page representation database on said server;
modifying said database entry in conformity with said directed modification;
generating an updated version of said test web page from said web page representation database;
displaying said updated test web page; and
repeating said first receiving, said first sending, said locating, said second modifying, said generating and said displaying until a third user input is received for terminating said editing session.

2. The method of claim 1, wherein said generating comprises interpreting said web page representation database at said server to produce an output representing said test web page, and wherein said displaying comprises pushing said output to said browser from said server.

3. The method of claim 2, further comprising:
third receiving a user input commanding publication of said test web page; and
responsive to said third receiving, copying said output over a file corresponding to said active web page, whereby said active web page is replaced by said updated test web page.

4. The method of claim 2, wherein said output is a dynamically generated output representing said active web page, generated upon access to said web page at said server from said web page representation database, and wherein said method further comprises:
third receiving a user input commanding publication of said test web page; and
responsive to said third receiving, copying said updated database over a second database from which said active web page was previously generated, whereby said active web page is replaced by said updated test web page.

5. The method of claim 1, wherein said first receiving receives a double-click user input and further comprising:
responsive to said first receiving, floating a layer containing said object within said test web page by adjusting a position of said layer in conformity with motion of said pointing device, and wherein said second receiving receives a single-click user input deselecting said object;
responsive to said second receiving, ending said floating; further responsive to said second receiving, second sending second screen coordinates associated with said first user input to said server, and wherein said modifying repositions said object by updating a location of said object within said database entry in conformity with said second screen coordinates.

6. The method of claim 1, wherein said first receiving receives a single-click user input and further comprising responsive to said first receiving, regenerating said test web page to include a superimposed menu bar occupying a fixed position in said test web page view.

7. The method of claim 6, further comprising:
third receiving a third user input commanding a scroll of said test web page at said browser; and
responsive to said third receiving, relocating said superimposed menu bar at said fixed position, whereby said test web page may be scrolled without moving said menu bar.

8. The method of claim 6, further comprising
third receiving one or more user inputs selecting one or more objects within said test web page;
performing menu actions of said menu bar on said one or more objects in said database, whereby groups objects in said web page can be edited from a single action selectable from said menu bar.

9. The method of claim 1, further comprising:
third receiving a fourth user input selecting a database object having a predetermined type;
responsive to said third receiving, invoking a database editor associated with said predetermined type; and
responsive to said third receiving, regenerating said test web page to display a view of said database editor within said test web page view, whereby data associated with said database object maybe edited by interacting with said database editor within said test web page view.

10. The method of claim 1, further comprising responsive to said first receiving, generating a cross-hair within said test web page view reflecting a position of said pointing device.

11. The method of claim 1, further comprising:
responsive to said first receiving, determining whether or not said object exists at said first screen coordinates;
responsive to determining that said object exists, selecting said object; and
responsive to determining that said object does not exist, providing an option of inserting a new object as said selected object.

12. A server system for editing and displaying an active web page during a live Internet session displaying a test version of said active web page in a page view window of a browser executing on an user computer having a visual display and a pointing device, said end-user computer further coupled to said server via an Internet connection, said server system having a processor for executing server program instructions and a memory coupled to said processor for containing said server program instructions and data, and wherein said server program instructions comprise program instructions for:
first pushing said test web page including user interface helpers merged with content of said test web page to said browser;
first receiving from said user interface helpers, a first user input from a selector of said pointing device at a location on-said test web page;
second receiving from said user interface helpers, a second user input directing modification of an object in conjunction with said first user input;
locating a database entry for said object within a web page representation database on said server;
modifying said database entry in conformity with said directed modification;
generating an updated version of said test web page from said web page representation database;
second pushing said updated test web page to said browser; and
repeating said first receiving, said second receiving, said locating, said modifying, said generating and said second pushing until a third user input is received from said user interface helpers for terminating said editing session.

13. The server system of claim 12, wherein said server program instructions further comprise program instructions for:
third receiving a user input commanding publication of said test web page; and
responsive to said third receiving, copying said output over a file corresponding to said active web page, whereby said active web page is replaced by said updated test web page.

14. The server system of claim 12, wherein said output is a dynamically generated output representing said active web page, generated upon access to said web page at said server from said web page representation database, and wherein said server program instructions further comprise program instructions for:
third receiving a user input commanding publication of said test web page; and
responsive to said third receiving, copying said updated database over a second database from which said active web page was previously generated, whereby said active web page is replaced by said updated test web page.

15. The server system of claim 12, wherein said first pushing pushes a test web page including user interface helpers including browser program instructions for:
determining whether or not said first receiving received a double-click user input;
responsive to determining that said first receiving received a double-click user input, floating a layer containing said object within said test web page by adjusting a position of said layer in conformity with motion of said pointing device, and wherein said second receiving receives a single-click user input deselecting said object;
responsive to said second receiving, ending said floating; further responsive to said second receiving, second sending second screen coordinates associated with said first user input to said server, and wherein said modifying repositions said object by updating a location of said object within said database entry in conformity with said second screen coordinates.

16. The server system of claim 12, wherein said program instructions for first pushing push a test web page including user interface helpers including browser program instructions for:
determining whether or not said first receiving received a single-click user input; and
responsive to determining that said first receiving received a single-click user input, activating a superimposed menu bar occupying a fixed position in said test web page view.

17. The server system of claim 16, wherein program instructions for first pushing push interface helpers further including browser program instructions for:
third receiving a an indication from said browser indicating a scroll of said test web page; and
responsive to said third receiving, relocating said superimposed menu bar at said fixed position, whereby said test web page may be scrolled without moving said menu bar.

18. The server system of claim 16, wherein said program instructions for first pushing push user interface helpers further including browser program instructions for:
third receiving one or more user inputs selecting one or more objects within said test web page;
sending menu actions of said menu bar to said server, and wherein said server program instructions further comprise program instructions for modifying entries for said one or more objects in said database, whereby groups objects in said web page can be edited from a single action selectable from said menu bar.

19. The server system of claim 12, wherein said server program instructions further comprise program instructions for:
third receiving a fourth user input selecting a database object having a predetermined type;
responsive to said third receiving, invoking a database editor associated with said predetermined type; and
responsive to said third receiving, regenerating said test web page to display a view of said database editor within said test web page view, whereby data associated with said database object maybe edited by interacting with said database editor within said test web page view.

20. The server system of claim 12, wherein said program instructions for first pushing push a test web page including user interface helpers including browser program instructions for generating and moving a cross-hair within said test web page view reflecting a position of said pointing device.

21. The server system of claim 12, wherein said server program instructions further comprise program instructions for:
responsive to said first receiving, determining from said web page representation database whether or not said object exists at said first screen coordinates;
responsive to determining that said object exists, selecting said object; and
responsive to determining that said object does not exist, providing an option of inserting a new object as said selected object.

22. A computer program product comprising signal-bearing media containing program instructions for execution on a server, for editing and displaying an active web page during a live Internet session displaying a test version of said active web page in a page view window of a browser executing on an user computer having a visual display and a pointing device, said end-user computer further coupled to said server via an Internet connection, said program instructions comprising program instructions for:
first pushing said test web page including user interface helpers merged with content of said test web page to said browser;
first receiving from said user interface helpers, a first user input from a selector of said pointing device at a location on said test web page;
second receiving from said user interface helpers, a second user input directing modification of an object in conjunction with said first user input;
locating a database entry for said object within a web page representation database on said server;
modifying said database entry in conformity with said directed modification;
generating an updated version of said test web page from said web page representation database;
second pushing said updated test web page to said browser; and
repeating said first receiving, said second receiving, said locating, said modifying, said generating and said second pushing until a third user input is received from said user interface helpers for terminating said editing session.

23. The computer program product of claim 22, wherein said server program instructions further comprise program instructions for:
third receiving a user input commanding publication of said test web page; and
responsive to said third receiving, copying said output over a file corresponding to said active web page, whereby said active web page is replaced by said updated test web page.

24. The computer program product of claim 22, wherein said output is a dynamically generated output representing said active web page, generated upon access to said web page at said server from said web page representation database, and wherein said server program instructions further comprise program instructions for:
third receiving a user input commanding publication of said test web page; and
responsive to said third receiving, copying said updated database over a second database from which said active web page was previously generated, whereby said active web page is replaced by said updated test web page.

25. The computer program product of claim 22, wherein said first pushing pushes a test web page including user interface helpers including browser program instructions for:
determining whether or not said first receiving received a double-click user input;
responsive to determining that said first receiving received a double-click user input, floating a layer containing said object within said test web page by adjusting a position of said layer in conformity with motion of said pointing device, and wherein said second receiving receives a single-click user input deselecting said object;
responsive to said second receiving, ending said floating; further responsive to said second receiving, second sending second screen coordinates associated with said first user input to said server, and wherein said modifying repositions said object by updating a location of said object within said database entry in conformity with said second screen coordinates.

26. The computer program product of claim 22, wherein said program instructions for first pushing push a test web page including user interface helpers including browser program instructions for:
determining whether or not said first receiving received a single-click user input; and
responsive to determining that said first receiving received a single-click user input, activating a superimposed menu bar occupying a fixed position in said test web page view.

27. The computer program product of claim 26, wherein program instructions for first pushing push interface helpers further including browser program instructions for:
third receiving a an indication from said browser indicating a scroll of said test web page; and
responsive to said third receiving, relocating said superimposed menu bar at said fixed position, whereby said test web page may be scrolled without moving said menu bar.

28. The computer program product of claim 26, wherein said program instructions for first pushing push user interface helpers further including browser program instructions for:
third receiving one or more user inputs selecting one or more objects within said test web page;
sending menu actions of said menu bar to said server, and wherein said server program instructions further comprise program instructions for modifying entries for said one or more objects in said database, whereby groups objects in said web page can be edited from a single action selectable from said menu bar.

29. The computer program product of claim 22, wherein said server program instructions further comprise program instructions for:
third receiving a fourth user input selecting a database object having a predetermined type;
responsive to said third receiving, invoking a database editor associated with said predetermined type; and
responsive to said third receiving, regenerating said test web page to display a view of said database editor within said test web page view, whereby data associated with said database object maybe edited by interacting with said database editor within said test web page view.

30. The computer program product of claim 22, wherein said program instructions for first pushing push a test web page including user interface helpers including browser program instructions for generating and moving a cross-hair within said test web page view reflecting a position of said pointing device.

31. The computer program product of claim 22, wherein said server program instructions further comprise program instructions for:
responsive to said first receiving, determining from said web page representation database whether or not said object exists at said first screen coordinates;
responsive to determining that said object exists, selecting said object; and
responsive to determining that said object does not exist, providing an option of inserting a new object as said selected object.

32. A graphical user interface method for editing web content within a browser window from a server, comprising:
displaying a test version of a web page;
receiving a first user input directing entry of an editing mode and selecting a location in a test web page view;
responsive to said first user input, determining whether or not a type of said first user input is a single-click or a double click;
responsive to determining that said user input type is a double-click, floating an object located at said location in said test web page view.

33. The method of claim 32, further comprising responsive to determining that said first user input type is a single-click, activating a menu bar at a fixed location within said test web page view.

34. The method of claim 33, further comprising:
second receiving a second user input indicating completion of modification of an object at said menu bar;
responsive to said second user input, deactivating said menu bar.

35. The method of claim 33, further comprising:
scrolling said browser window to move said test web page view; and
responsive to said scrolling, repositioning said menu bar to remain at said fixed position within said test web page view.

36. A computer system for editing and displaying an active web page during a live Internet session in conjunction with a server, said computer system having a processor for executing browser program instructions and a memory coupled to said processor for containing said browser program instructions and data including web page program instructions loaded in said test version of said active web page, said browser displaying a test version of said active web page in a page view window and executing on an user computer having a visual display and a pointing device, said user computer further coupled to said server via an Internet connection, and wherein said browser program instructions comprise program instructions for:
displaying a test version of a web page directing entry of an editing mode and selecting a location in a test web page view;
responsive to user input, determining whether or not a type of said user input is a single-click or a double click;
responsive to determining that said user input type is a double-click, floating an object located at said location in said test web page view.

37. The computer system of claim 36, wherein said program instructions further comprise program instructions for activating a menu bar at a fixed location within said test web page view, responsive to determining that said user input type is a single-click.

38. The computer system of claim 37, wherein said program instructions further comprise program instructions for:
second receiving a second user input indicating completion of modification of an object at said menu bar;
responsive to said second user input, deactivating said menu bar.

39. The computer system of claim 37, wherein said program instructions further comprise program instructions for:
scrolling said browser window to move said test web page view; and
responsive to said scrolling, repositioning said menu bar to remain at said fixed position within said test web page view.

40. A computer program product comprising signal-bearing media containing program instructions for execution within a browser executing on a general purpose computer system, said program instructions for editing and displaying an active web page during a live Internet session displaying a test version of said active web page in a page view window of said browser, said end-user computer further coupled to said server via an Internet connection, said program instructions comprising program instructions for:
pushing a test version of a web page to said browser;
receiving an indication from said browser of a user input within said test web page view directing entry of an editing mode; and
regenerating, at said server, said test web page to include superimposed editing features in said test web page view displaying a test version of a web page directing entry of an editing mode and selecting a location in a test web page view;
responsive to user input, determining whether or not a type of said user input is a single-click or a double click;
responsive to determining that said user input type is a double-click, floating an object located at said location in said test web page view.

41. The computer program product of claim 40, wherein said program instructions further comprise program instructions for activating a menu bar at a fixed location within said test web page view, responsive to determining that said user input type is a single-click.

42. The computer program product of claim 41, wherein said program instructions further comprise program instructions for:
second receiving a second user input indicating completion of modification of an object at said menu bar;
responsive to said second user input, deactivating said menu bar.

43. The computer program product of claim 41, wherein said program instructions further comprise program instructions for:
scrolling said browser window to move said test web page view; and
responsive to said scrolling, repositioning said menu bar to remain at said fixed position within said test web page view.
